(19) United States
(12) Patent Application Publication
(10) Pub. No.: US 2015/0300465 A1
(43) Pub. Date: Oct. 22, 2015

(54) INDUSTRIAL AUTOMATION DEVICE

(71) Applicant: TELEROBOT S.P.A., Genova, (IT)

(72) Inventors: Francesco BECCHI, Genova (GE) (IT); Mario SCARRONE, Genova (GE) (IT)

(73) Assignee: TELEROBOT S.P.A., Genova (GE) (IT)

(21) Appl. No.: 14/440,833

(22) PCT Filed: Nov. 5, 2013
(86) PCT No.: PCT/IB2013/059901

§ 371 Date: May 5, 2015

(30) Foreign Application Priority Data
Nov. 5, 2012 (EP) 12191313.1

(51) Int. Cl. F16H 25/20; B23P 23/00

(52) U.S. Cl. CPC F16H 25/20; B23P 23/00; F16H 2025/2062; F16H 2025/2075

(57) ABSTRACT

Provided is an industrial automation device including a plurality of handling groups configured to handle an object defining a handling direction; a support structure configured to support and handle said handling groups; and wherein each of said handling groups includes at least one moving element configured to handle said object; handling and translating means of said moving element configured to permit the independent control of said rotation and translation, in terms of position, speed and acceleration.

Subject of the present invention is an industrial automation device of the type specified in the preamble of the first claim.

In particular, the invention concerns a device able to support or replace an operator, by performing predefined operations in an industrial production and/or assembly process. In particular, the invention concerns a manipulator, i.e. a device apt to handle, assemble or move objects. More particularly, it is provided with a plurality of handling devices, called spindles, being mutually independent and each apt to perform the same sequence of operations representing the scope of the machine or a subassembly of such operations.

It is known in the industrial production that two different types of automated plants are identified: plants with high flexibility, in which a manipulator or a series of manipulators perform by means of various aids a programmable assembly sequence, and plants with high throughput, in which a manipulation system mainly working with mechanical, hydraulic or pneumatic actuation, performs a given sequence of preset operations, through a series of rigid configurations of the machine by means of mechanical cams.

A particular type of plants of this second category consists in a cyclic assembling machines with multiple spindles. In this type of machines a plurality of devices, just called spindles, performs a series of operations with a plurality of spindles and these sequentially perform the same task on subsequent pieces produced, with the corresponding advantage that very high production throughputs can be obtained. The preferred configuration of this type of plants is the so-called carousel, the spindles rotating around a main axis. From these basic configurations other compositions can be derived, in which the machine is a composition of carousels or machines in which the composition of the spindles occurs differently, as for example along a mechanical transmission chain, the main advantage of this further version consisting in the possibility of getting more freedom for exploiting the layout of the machine as seen from above.

With further reference to the machines having high working throughput with multiple spindles, the following important limits are found.

The first limit concerning these machines is the reduced or zero possibility of program reconfiguration.

Another important drawback of the known industrial automation devices is represented by the high complexity of construction: the high speeds and precisions required at assembling with high throughput require a very strong and accurate mechanical solution with a delicate and modifiable set-up, just by directly acting on the different regulations and calibrations.

Finally, it is generally known that this type of devices permits the possible calibration of the sequence of the machine during the calibration phase, but that such calibrations are generally fixed up to the subsequent calibration operation and in any case they cannot be continuously regulated with the machine in operation.

In this situation, the technical task of the present invention is to realize an industrial automation device, apt to substantially obviate the cited drawbacks.

Within said technical task, an important aim of the invention is to realize an industrial automation device with high flexibility.

Another important aim of the invention is to provide a device being characterized by high reliability.

Another important aim is to obtain a device being easily regulated, in order to be rapidly adapted to any working condition.

The technical task and the specified aims are obtained by an industrial automation device, as claimed in the annexed claim 1.

Preferred embodiments are pointed out in the subclaims.

The characteristics and advantages of the invention are explained in the following by the detailed description of a preferred embodiment of the invention, with reference to the annexed drawings, in which:

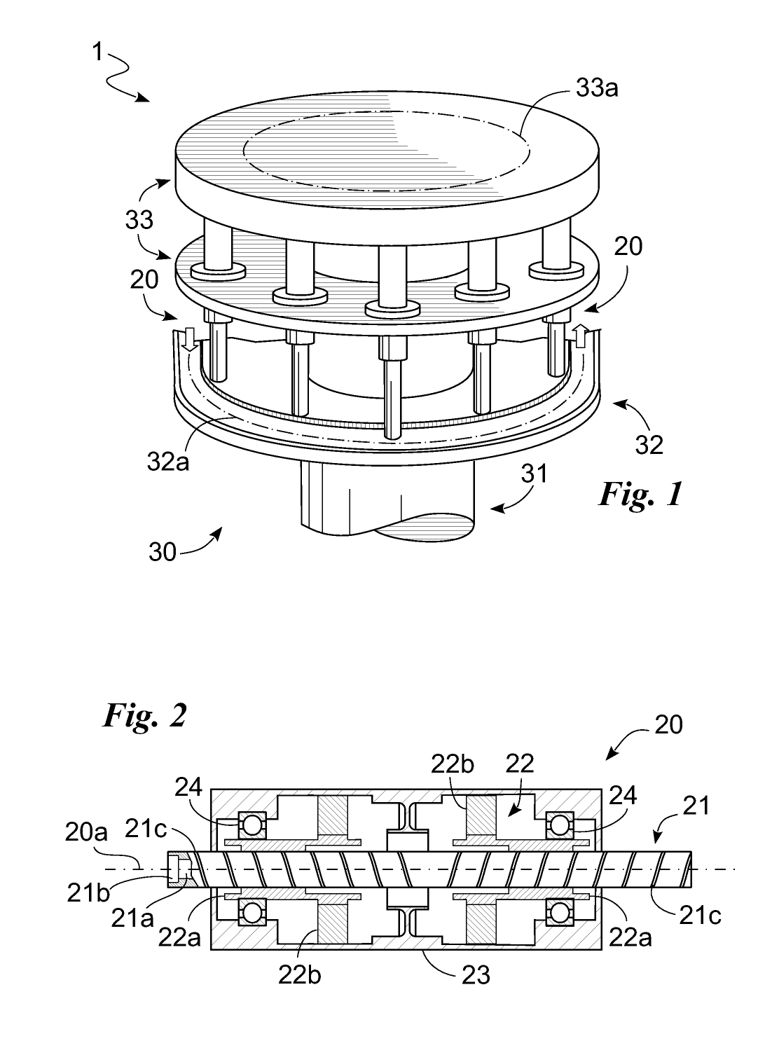

FIG. 1 shows an industrial automation device;

FIG. 2 points up a detail of the industrial automation device according to the invention.

With reference to the cited figures, the industrial automation device according to the invention is globally indicated with number 1. It is apt to support or replace an operator in an industrial production process, by performing predefined operations such as for example, gripping, handling and assembling. The industrial automation device 1 can therefore be preferably identified with a manipulator, apt to handle at the same time and mutually independently a plurality of objects, such as to permit their assembly on a base group.

In particular, the industrial automation device 1 is a manipulator for objects made of complex bottle caps, more particularly special caps such as those for the base groups made of cardboard, such as cartons and similar or for liquors, which need particular working.

The industrial automation device 1 mainly comprises one or more handling groups 20, each of them being apt to handle the object to assemble; and a support structure 30 apt to support the handling groups 20 and the base groups on which the objects can be held, for example a flange with a cap interface with respect to the bottle or carton.

The support structure 30 comprises a central support 31, preferably with a cylindrical shape, apt to support a plurality of handling groups 20; a workstation 32 apt to handle the base groups along a production line 32a with integral motion; and a loading station, not shown in the figure, apt to store said objects, permitting their withdrawal by means of the handling groups 20.

Furthermore, the support structure 30 has a sliding unit 33 integral with handling groups 20 and movable with respect to the central support 31, such as to move the handling groups 20 along a preferably closed path 33a, at least partially coincident with said production line 32a. Preferably, the closed path 33a is substantially circular and the handling speed of the groups 20 and so of the objects to be handled, is substantially equal to that of the base assemblies, defined by the workstation 32.

With reference to unit 33, the industrial automation device 1 has at least one handling group 20 apt to move an object, by defining a handling path 20a being preferably substantially transversal, and more preferably being substantially perpendicular to the deposition plane of the production line 32a and still more preferably, being substantially parallel to the gravity gradient.

In particular, the industrial automation device 1 advantageously has a plurality of handling groups 20, which define handling directions 20a, preferably and substantially parallel one another.

Each handling group 20 comprises at least one moving element 21 apt to grip and handle an object and handling and translating means, apt to handle and translate at least one moving element 21, apt in particular to permit the independent control of the rotation and translation in terms of position, speed and acceleration.

In a preferred embodiment of an example shown in FIG. 2, the handling group 20 comprises one or more moving element 21; a handling apparatus 22, apt to handle the moving elements 21; a frame 23 apt to be bound to the sliding unit 33 and to define a housing for means 22 and for at least one part of the element 21; and bushes 24 or other similar elements, apt to permit to the moving element 21 to translate and/or slide with respect to the frame 23.

Each moving element 21 can be identified in a profile or other similar element, defining a substantially linear extending direction and preferably, substantially parallel to the sliding direction 20a.

Furthermore, it has an inner cavity 21a, preferably a through hole, provided, at its lower end, i.e. near the station 31, of a seat 21b, shaped in order to house at least one portion of the cap or the object to handle.

The inner cavity 21a is connected with a fluid passage with a pump or another similar device, apt to change the pressure in the seat 21b and, preferably housed in the frame 23. More particularly, the pump is apt to define a withdrawal/transport operation, in which the inner cavity 21a and the seat 21b are kept in such a depression as to return or bind the cap to the seat 21b, and a releasing action, in which the pressure in the inner cavity 21a and in the seat 21b is higher, permitting to the cap to exit from the seat 21b, substantially due to its weight.

Alternatively or in addition to the inner cavity 21a, the element 21 can have gripping means, not shown in terms of measure, identifiable as a gripper, a spindle or another gripping means, apt to perform a mechanical gripping of at least one object.

Preferably, such an organ is apt to perform a gripping operation according to a predetermined position of the object, with respect to the same means, i.e. by placing the gripped object in a determined position.

The handling means 22, as described later, define for the moving element 21 a rotation, substantially around its handling direction 20a and with a translation substantially parallel to the direction 20a.

Therefore, they comprise one or more engaging bodies 22a apt to engage with threads 21c suitably made along the outer lateral surface 21 and at least one motor 22b apt to rotate the engaging bodies 22a around its direction 20a by varying, in a mutual independent way, at least with the direction of rotation.

The engaging bodies 22a can be identified as nuts, and preferably nuts with a recirculation of spheres, i.e. having spheres interposed between the thread 21c of the moving element 21 and the thread of the engaging bodies 22a. The motor 22b can control a mode in the same direction of the engaging bodies 22a, defining a rotation of each moving element 21 substantially in the handling direction 20a. Alternatively, it could control mutually opposed rotations of the bodies 22a, by imposing a translation of the element 21 substantially along the handling movement 20a and causing the rotation of the moving element 21.

Preferably, the engaging bodies 22a are apt to rotate, apart from varying their rotary direction, with a substantially different module speed, so that the moving element 21 can perform a rotary translation with respect to the handling movement 20a with a rotary and translation speed which is variable with respect to the bodies 22a.

In order to permit such an independent handling of the engaging bodies 22a, each of the handling means 22 have two motors 22b, each of them associated with one of the engagement bodies 22a.

Alternatively, the handling means 22 have a single motor 22b, provided with a gear or other similar cinematic element, apt to modify the transmission relationship between the motor 22b and each body 22a, in particular the reverse portion, and more particularly the module of the rotation speed of the bodies 22a.

The motors 22b are, preferably, electrical and more preferably, they are brushless motors.

The operation of an industrial automation device, which was described previously in a structural way, is the following.

First of all, the working station 32 and the sliding unit 33 respectively move the base groups along the production line 32a and the handling assemblies 20 along the closed path 33a. In detail, said movements are continuous i.e. without interruption, and preferably with substantially mutual advancing speeds.

During such movement, the unit 33 places a handling group 20 at the loading station, so permitting the withdrawal of an object by said handling group 20 and by performing the required work. Said withdrawal takes place by means of the inner cavity 21a, maintained in a depression condition so as to return and bind the cap in the seat.

In particular, if the motors 22b rotate the engagement bodies 22a with a rotation speed having the same module and an opposed direction, the moving element 21 translates along the handling direction 20a. More particularly, the bodies 22a, by rotating with respect to the moving element 21, generate on the latter four distinct forces: two tangential forces with respect to the element 21 and being substantially mutually opposed, so as to cancel each other; and two axial forces, i.e. in practice parallel to the substantially equal direction 20a, so as to translate the moving element 21 along the handling direction 20a.

On the contrary, if the motors 22b rotate the engaging bodies 22a with a substantially equal speed and rotation directions, the moving element 21 rotates with respect to the handling direction 20a. In particular, the engaging bodies 22a, having a speed with substantially the same direction and the same module, impose to the moving element 21 four forces: two tangential forces, substantially and mutually equal so as to apply on the element 21 a shift and so a rotation substantially along the handling direction 20a; and two axial forces substantially and mutually opposed, and which, therefore cancel each another.

Furthermore and as an alternative, if a rotary translation of the moving element 21 is required, with respect to the handling direction 20a, the motors 22b rotate the engagement bodies 22a with substantially different speeds. In detail, in this case the engagement bodies 22a impose to the element 21 two tangential forces and two axial forces which respectively determine a shift/rotation with respect to the handling direction 20a, and at the same time, a translation along the direction 20a.

The invention permits important advantages.

A first important advantage of the industrial automation device 1 is represented by the high simplicity of construction.

As a matter of fact, despite the presence of a high number of handling groups 20, the industrial automation device is characterized by a reduced number of components, thanks to the new cinematic element of the groups 20.

Another advantage is therefore represented by the high reliability and so by the reduced number of maintenance operations or failure of the device 1.

Another advantage is therefore represented by reduced times and production costs, which can be obtained thanks to the industrial automation device 1.

Said advantages are furthermore highlighted by the use of engagement bodies 22a with the recirculation of spheres which guarantee high precision and long operating life.

An important advantage is also represented by the fact that, thanks to the particular cinematic element recognised by each handling organ 20, the device 1 cab be easily regulated, and so it is able to adapt its own operation to the assembly needs.

In particular, by varying the speed and the acceleration of the engagement bodies 22a, it is possible not only to modify the movement of the moving element 21 as before, but also to modify the strength or the assembly mode and, so realizing the assembly both of particularly delicate and fragile components and permitting the connection with other assemblies which need a high strength application.

Such an advantage is particularly important in manipulators and above all in manipulators with bottle caps, in more detail special caps such as those for cardboard envelopes, such as cartons or similar for liquors, which need particular working, and pairs with variable strengths inside the same operation.

In fact, by means of a suitable regulation of the rotation speed of the bodies 22a it is possible to regulate the stroke and the strength performed by the handling group 20 and therefore, to adapt the operation of the device 1 to the specified properties.

Such flexibility and precision of working of the device are further increased by the use of motors 22b of brushless type and by engagement bodies 22a with a recirculation of spheres, obtaining a great precision of movements of the moving element 21.

The invention can be subjected to variants which are all comprised within the scope of the inventive concept. All the elements described and claimed are substituted by equivalent elements and the details, materials, shapes and sizes can be of any kind.

1. An industrial automation device, comprising:
a plurality of handling groups configured to handle an object, by defining a handling direction, each of said handling groups comprises
at least one moving element configured to handle said object, and
handling and translating means of said moving element configured to permit the independent control of said rotation and translation, in terms of position, speed and acceleration; and
a support structure configured to support and handle said handling groups.

2. The industrial automation device according to claim 1, wherein said at least one moving element comprises two mutually opposed threads, and wherein each one of said handling groups further comprises at least two engagement bodies, each of said engagement bodies being configured to engage with one of said threads; and at least one motor configured to rotate said engagement bodies; said at least one motor being configured to mutually vary at least the rotary direction of said at least two engagement bodies by defining, for said at least one moving element, a rotation substantially around said sliding direction when said at least two engagement bodies have the same rotary directions and a translation substantially along said sliding direction when said at least two engagement bodies have opposed rotary directions.

3. The industrial automation device according to claim 2, wherein said at least one motor is configured to mutually vary the module of the rotation speeds of said at least two engagement bodies by defining a rotary translation of said at least one moving element with respect to said sliding direction, when said rotation speed of said at least two engagement bodies has a different module.

4. The industrial automation device according to claim 2, wherein each of said handling groups comprises two of said engagement bodies and two of said motors, each of said motors being associated with one of said engagement bodies.

5. The industrial automation device according to claim 2, wherein said at least one motor is brushless.

6. The industrial automation device according to claim 2, wherein said at least two engagement bodies have a recirculation of spheres.

7. The industrial automation device according to claim 1, wherein said handling groups define handling directions substantially parallel each other.

8. The industrial automation device according to claim 1, wherein said at least one moving element has an inner cavity configured to permit the withdrawal of said object according to a depression phase.

9. The industrial automation device according to claim 1, wherein at least one moving element has a substantially linear extending direction.

10. The industrial automation device according to claim 9, wherein said development direction is substantially parallel to the sliding direction.
